(19) United States
(12) Patent Application Publication
(10) Pub. No.: US 2025/0027616 A1
(43) Pub. Date: Jan. 23, 2025

(54) SYSTEM FOR PRECOOLING A HYDROGEN FUEL DISPENSER

(71) Applicant: ZEV Station Holding, LLC, Chandler, AZ (US)

(72) Inventors: Jesse Schneider, Chandler, AZ (US); Bob Boyd, Spring Lake, NJ (US)

(21) Appl. No.: 18/779,893

(22) Filed: Jul. 22, 2024

Related U.S. Application Data
(60) Provisional application No. 63/528,188, filed on Jul. 21, 2023.

(51) Int. Cl. F17C 13/08; F17C 1/00; F17C 11/00

(52) U.S. Cl. CPC F17C 13/084; F17C 1/005; F17C 11/005; F17C 2227/0135; F17C 2227/03

(57) ABSTRACT

A hydrogen fueling system for vehicles includes a hydrogen storage tank holding liquid hydrogen, 400 to 500 bar storage systems for compressed hydrogen, and hydrogen dispensers providing fuel to vehicles. A pump circulates hydrogen from the storage tank through a heat conditioning system to the dispenser at a desired fueling temperature. A control system manages pump flow through the dispenser supply system, precooling the dispensers and supplementing flow from storage when fueling vehicles with onboard storage exceeding 250 liters. This system efficiently delivers hydrogen fuel to vehicles, ensuring optimal fueling conditions and accommodating varying storage capacities.

### CROSS-REFERENCE TO RELATED APPLICATIONS

This application claims the benefit of and priority to U.S. Provisional Application 63/528,188, titled “System for Precooling a Hydrogen Fuel Dispenser”, filed Jul. 21, 2023, the contents of which are incorporated by reference herein.

### TECHNICAL FIELD OF THE INVENTION

This disclosure relates to a system for precooling a hydrogen fuel dispenser.

### BACKGROUND

Hydrogen powered vehicle fueling protocols specify various fuel delivery rates and the associated fuel dispenser temperatures required to support these fuel delivery rates. One such standard is SAE J2601/x-Fueling Protocols for Light Duty Gaseous Hydrogen Surface Vehicles published by the society of Automotive Engineers (SAE) for vehicles with total volume capacities greater than or equal to 49.7 L. SAE J2061 specifies three fuel delivery temperature categories denoted by a “T” rating: T40 (−40° C.), T30 (−30° C.), and T20 (−20° C.), where T40 is the coldest. Under reference conditions, SAE J2601 has a performance target of a fueling time of 3 minutes and a state of fill of 95 to 100%, which can be achieved with a T40-rated dispenser having communication between the dispenser and the vehicle being fueled. However, with higher fuel delivery temperature dispenser ratings (T30 or T20) and/or at high ambient temperatures, fueling times may be longer.

For medium duty and heavy duty SAE J2601-5 has been published in 2024 as a technical information report and supports vehicle fueling at fueling speeds of up to 90, 120 and 300 grams per second. Once field validated the protocols will be integrated into ISO standards and incorporated into SAE J2601-1 to enable support for vehicles with onboard storage from 49.7 liters to over 1200 liters (water capacity).

These protocols include table based parameters based on worst case fueling conditions for various fuel temperature ranges and formulas based on mass average fuel temperate and measured and transmitted vehicle tank temperature.

Previous approaches to hydrogen fueling systems have typically involved storing hydrogen in either liquid or compressed form to facilitate efficient and safe refueling of vehicles powered by hydrogen fuel cells. Liquid hydrogen storage tanks have been utilized to store hydrogen at cryogenic temperatures, allowing for a high volumetric energy density. However, the handling and storage of liquid hydrogen present challenges due to the need for specialized equipment and insulation to maintain the low temperatures required for storage. On the other hand, compressed hydrogen storage systems operate at high pressures to achieve a high gravimetric energy density but require robust containment vessels to ensure safety during storage and dispensing.

Hydrogen dispensers play a crucial role in delivering hydrogen fuel to vehicles equipped with fuel cell systems. Traditional hydrogen dispensers have relied on pumps to transfer hydrogen from storage tanks to the dispensing nozzle, with the flow rate and temperature of the dispensed hydrogen being key factors in ensuring efficient and safe refueling operations. The control systems used in existing hydrogen fueling systems have been designed to regulate the flow of hydrogen from storage to dispensers, often incorporating precooling mechanisms to adjust the temperature of the hydrogen fuel to the desired level for efficient fueling.

Efforts to enhance the performance and versatility of hydrogen fueling systems have led to the development of storage systems capable of accommodating higher pressures, such as the 400 to 500 bar range specified in the present claim. These high-pressure storage systems offer advantages in terms of increased storage capacity and faster refueling times, but also require sophisticated control systems to manage the flow of hydrogen from storage to dispensers effectively. However, none of these approaches have provided a comprehensive solution that combines the features described in this disclosure.

### SUMMARY

A system for precooling a hydrogen fuel dispenser is presented herein. This system is configured to maintain a hydrogen fuel dispenser at a predetermined temperature threshold, e.g., −40° C., so that the fastest fueling protocol can be used immediately to reduce the time required to fuel a vehicle rather than waiting for the hydrogen fuel dispenser to cool down to the desired temperature before initiating fueling or reducing the fuel delivery rate to deliver the fuel at a higher temperature, e.g., −20° C. to −30° C.

In some aspects, the techniques described herein relate to a hydrogen fueling system configured to provide hydrogen fuel to a vehicle, including: a hydrogen storage tank containing delivered liquid hydrogen; one or more 400 to 500 bar storage systems to store compressed hydrogen; one or more hydrogen dispensers configured to supply hydrogen fuel to the vehicle: a pump configured to move the hydrogen fuel from the liquid hydrogen storage tank and circulate the hydrogen fuel through the heat condition system to supply hydrogen at the dispenser at a desired fueling temperature: and a control system to direct pump flow through the dispenser supply system to and fill storage to precool the dispensers and direct flow from storage to supplement the flow from the pump when fueling vehicles with onboard storage greater than 250 liters.

In some aspects, the techniques described herein relate to a hydrogen fueling system configured to provide hydrogen fuel to a vehicle, including: a first hydrogen storage tank; a hydrogen dispenser configured to supply hydrogen fuel to the vehicle; a pump configured to transport the hydrogen fuel from the first hydrogen storage tank to the hydrogen dispenser; and a second hydrogen storage tank, wherein the hydrogen fuel stored in the second hydrogen storage tank passes through a fixed orifice and mixes with the hydrogen fuel flowing from the pump within a venturi eductor.

In some aspects, the techniques described herein relate to a hydrogen fueling system configured to provide hydrogen fuel to a vehicle, including: a first hydrogen storage tank; a second hydrogen storage tank; a hydrogen dispenser configured to supply hydrogen fuel to the vehicle; a first pump configured to transport the hydrogen fuel from the first hydrogen storage tank to the hydrogen dispenser; a second pump configured to transport the hydrogen fuel from the first hydrogen storage tank to the hydrogen dispenser, wherein said hydrogen fueling system is configured to operate in a mode selected from a list consisting of: a light duty fueling mode wherein the first pump is directly connected from the first hydrogen storage tank to the hydrogen dispenser, a medium duty fueling mode wherein the first pump is connected from the first hydrogen storage tank to the hydrogen dispenser with a medium flow from the second hydrogen storage tank, a heavy duty fueling mode wherein the first pump is connected from the first hydrogen storage tank to the hydrogen dispenser with a high flow from the second hydrogen storage tank, and a heavy duty fast fueling mode wherein the first pump and the second pump is connected from the first hydrogen storage tank to the hydrogen dispenser with a high flow from the second hydrogen storage tank.

In some aspects, the techniques described herein relate to a method of operating a hydrogen fueling system configured to provide hydrogen fuel to a vehicle having a liquid hydrogen supply tank holding a quantity of liquid hydrogen at a first temperature, including: drawing the liquid hydrogen from the liquid hydrogen supply tank using a pump; feeding the liquid hydrogen from the pump to a first manifold that delivers a first portion of the liquid hydrogen to a heat exchanger that warms the first portion of the liquid hydrogen to a first hydrogen gas flow having a second temperature higher than the first temperature and delivers a second portion of the liquid hydrogen as a second hydrogen gas flow having a third temperature higher than the first temperature but lower than the second temperature; mixing the first hydrogen gas flow controlled by a first valve and second hydrogen gas flow controlled by a second valve in a second manifold provide a third hydrogen gas flow at a desired temperature; and providing the third hydrogen gas flow to a dispenser to cool and maintain the dispenser at the desired temperature.

### BRIEF DESCRIPTION OF THE DRAWINGS

The present invention is described, by way of example with reference to the accompanying drawings, in which:

FIG. 1 is a schematic diagram of a system for precooling a hydrogen fuel dispenser and supplementing pump capacity according to some embodiments.

FIG. 2 is a schematic diagram of a system for hydrogen fueling at a peak rate of 10 kg/min according to some embodiments.

FIG. 3 is an enlarged portion of the schematic diagram of the system of FIG. 2 according to some embodiments.

FIG. 4 is a schematic diagram of a system for boosting and economizing hydrogen fueling according to some embodiments.

FIG. 5 is a flow chart of a method of operating a hydrogen fueling system according to some embodiments.

### DETAILED DESCRIPTION

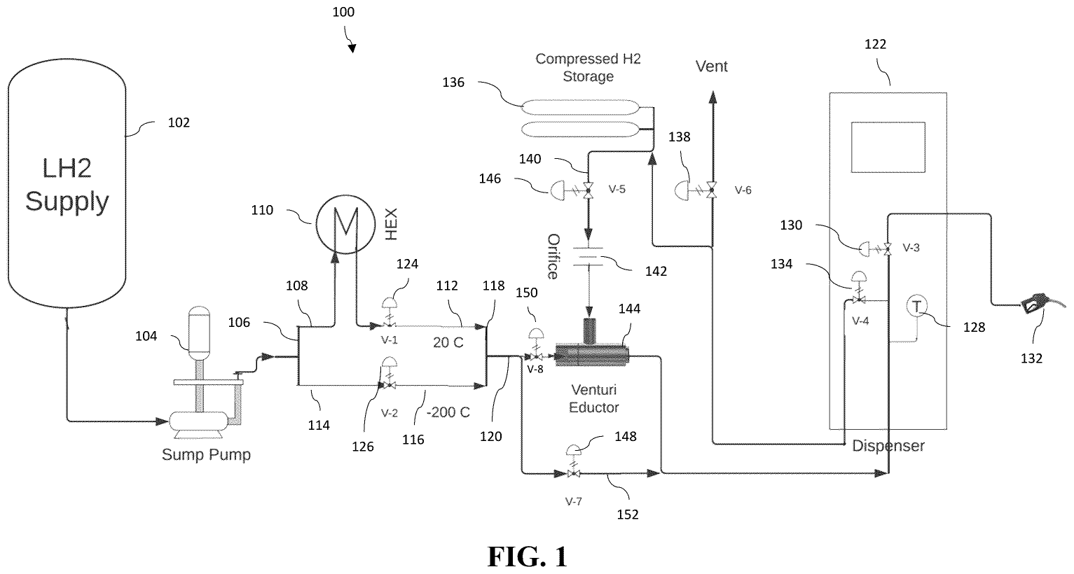

A non-limiting example of a system configured to precool a hydrogen fuel dispenser, hereafter referred to as the system 100, in order to reduce fueling times for a vehicle (not shown) by up to 30% is shown in FIG. 1. The system includes a liquid hydrogen (LH2) supply tank 102 holding a quantity of liquid hydrogen at a temperature of approximately −250° C. Liquid hydrogen is drawn from the supply tank 102 by a sump pump 104 and is fed to a first manifold 106 that delivers a first portion 108 of the liquid hydrogen flow through a heat exchanger 110 that warms the liquid hydrogen to a first hydrogen gas flow 112 having a temperature of approximately −20° C. to −40° C. and delivers a second portion 114 of the liquid hydrogen flow as second hydrogen gas flow 116 which after being warmed by the sump pump has a temperature of approximately −200° C. The first and second hydrogen gas flows 112, 116 are mixed in a second manifold 118 to provide a third hydrogen gas flow 120 at the desired temperature, e.g., −40° C. per the SAE J2601 T40 fueling standard, to a dispenser 122. The first hydrogen gas flow 112 is controlled by a first valve 124 and the second hydrogen gas flow 116 gas is controlled by a second valve 126 to obtain the third hydrogen gas flow 120.

The third hydrogen gas flow 120 flows through the dispenser 122 to cool and maintain the dispenser at the desired temperature monitored by a temperature sensor 128 in the dispenser 122. The third hydrogen gas flow 120 may be controlled by a third valve 130 to a fueling nozzle 132 configured to provide the third hydrogen gas flow 120 to a vehicle or may be controlled by a fourth valve 134 to a compressed hydrogen storage tank 136 depending on the folding status of the dispenser 122. If the compressed hydrogen storage tank 136 is full or otherwise unavailable, the third hydrogen gas flow 120 may be directed to a stationary hydrogen fuel cell by a fifth valve 138.

In the example system 100 presented in FIG. 1, the system 100 further includes means for integrating a fourth hydrogen gas flow 140 from the compressed hydrogen storage tank 136 into the third hydrogen gas flow 120 by passing the fourth hydrogen gas flow 140 through a fixed orifice 142 and into a venturi eductor 144 through which the third hydrogen gas flow 120 passes. This allows some of the hydrogen gas stored in the compressed hydrogen storage tank 136 to be recycled into the third hydrogen gas flow 120 which increases the mass flow rate of the third hydrogen gas flow 120 (through the Bernoulli principle) mixing the fourth hydrogen gas flow 140 with the third hydrogen gas flow 120 may also be used to control the desired temperature of the third hydrogen gas flow 120. The fourth hydrogen gas flow 140 is controlled by a sixth valve 146. When a seventh valve 148 is closed and an eighth valve 150 is open, the third hydrogen gas flow 120 will flow through the venturi eductor 144. When the seventh valve 148 is open and the eighth valve 150 is closed, the third hydrogen gas flow 120 will flow through a bypass 152 around the venturi eductor 144.

Alternative embodiments of the system may exclusively include a venturi eductor 144 or a bypass 152 to the venturi eductor 144 and do not require the seventh and eighth valves 148, 150 to control flow through one or the other.

The system 100 described herein may be implemented by manual control or preferably by automated control by the addition of electronic controllers, electronic sensors, and electrical actuators. The system 100 may include additional sensors, controllers, actuators, valves, and other devices not shown in FIG. 1 for the sake of simplicity. The system 100 provides the benefit of cold soaking the dispenser 122 to maintain the dispenser 122 at the desired temperature to meet the requirements for filing at the fastest allowable rate according to applicable standards, thus guaranteeing that the fastest fill rate is available at all times. Cold Soaking is the process of pre-conditioning the dispenser and piping components prior to fueling. The goal is for a temperature reduction of these components to overcome the warm thermal mass due to the ambient environment. The fueling temperature required for the SAE J2601 standard has a strict temperature window in order to start fueling, and this will take time to cool down so that fueling can start. The purpose of this system is to cold soak, using cold hydrogen in the piping and dispenser systems to precondition to be able to go quickly to the be within the bounds of the temperature window from SAE J2601 measured at both the temperature sensor near the dispenser and ultimately the hydrogen tank. Slow pumping the third hydrogen gas flow 120 through the dispenser 122 keeps the sump pump 104 running longer and so the sump pump 104 beneficially experiences fewer start/stop cycles. The system 100 may include one or more dispensers 122. The system 100 provides unique station fueling modularity and scalability, starting with one sump pump for light duty service and one sump pump for heavy duty service. Scalability comes with additional sumps for both more dispensers and fueling throughput. The system 100 allows for offtake from light duty/heavy duty sump pumps. During the times when the heavy duty hydrogen fueling dispenser is not being used (e.g., late night), it is possible to close the lane and use this to fill a larger tube trailer (e.g., 1 T) using the same cryo-pumping system.

The system 100 provides an additional benefit to slow fill offtake either/or fixed/removable storage tube trailers. The target fueling for heavy duty hydrogen trucks with a 100 kg tank is 8-10 kg/minute which means a 10-15 minute fueling which is on par with diesel. However, filling a mobile tube trailer with 750-1000 kg, may take up to 75 to 90 minutes to fill. This is what is meant by slow filling trailers.

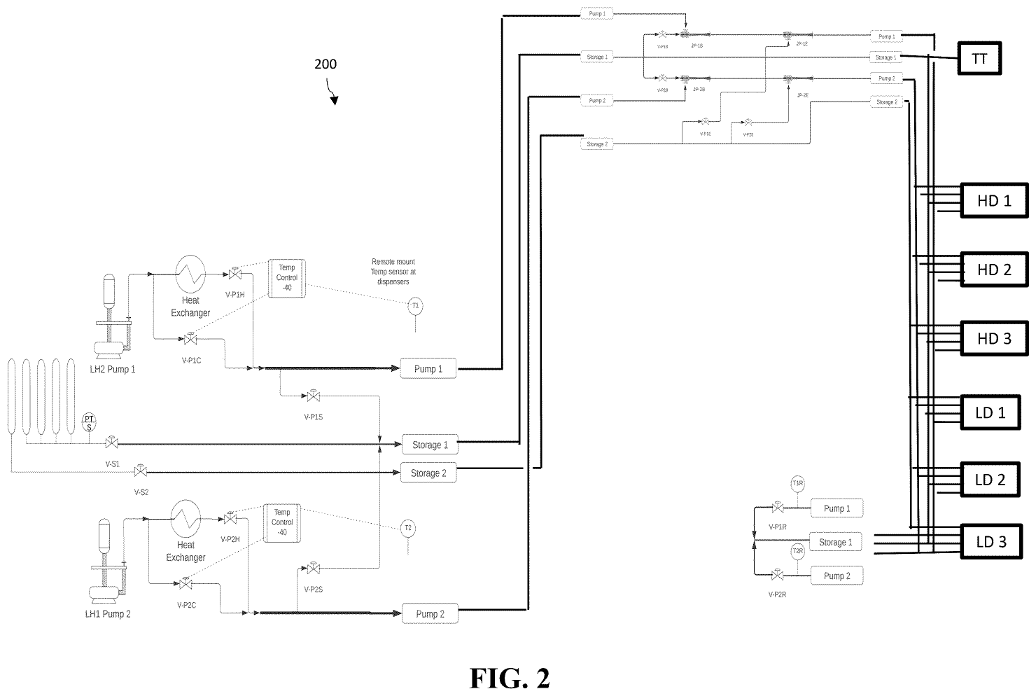

A non-limiting example of a system configured to provide hydrogen fueling at a peak rate of at least 10 kg/min in order to reduce fueling times for a vehicle (not shown), hereafter referred to as the system 200, is shown in FIG. 2.

The system 200 is configured to provide hydrogen fueling for light duty vehicles with a delivery temperature of T40 and to provide hydrogen fueling for heavy duty vehicles with a delivery temperature of T20. The system may also support other delivery temperatures specified in the SAE J2601 standard, such as T_{Ambient}, T0, T20 and T40Y. The system 200 can provide 250 kg of stationary hydrogen storage at a pressure of 50 Mpa with an optional additional 250 kg of mobile hydrogen storage at a pressure of 50 Mpa. Connection point HD1 may be configured for connection to a mobile storage tank, such as a truck or trainer mounted tank. HD1 may be configured to accommodate a precooled transfer temperature of −20° C. or non-precooled transfer from the mobile storage tank. Flow of hydrogen into the storage loop for temperature preconditioning may be sourced from either Storage 1 or Storage 2.

The system 200 may be configured to operate is several different modes:
Light Duty Fueling-one pump directly connected to a dispenser with light flow (around 2-3 kg/minute). Buffer storage may also be included. A bypass valve may be activated if the buffer storage is not available (not needed, empty, not connected, etc.);
Medium Duty Fueling-one pump connected to a dispenser with medium flow (around 5 kg/minute) from storage;
Heavy Duty Fueling-one pump connected to a dispenser with high flow (around 10 kg/minute) from storage; and
Heavy Duty Fast Fueling-two pumps connected to a dispenser with high flow (around 10 kg/minute) from storage.

H70 for the Heavy Duty Fast Fueling mode requires a large ID nozzle, hose, and break-away configured to accommodate 300 g/s peaks and 10 kg/minute fueling. There is a 450 bar fill of tube trailer in the Heavy Duty Fueling and Heavy Duty Fast Fueling modes.

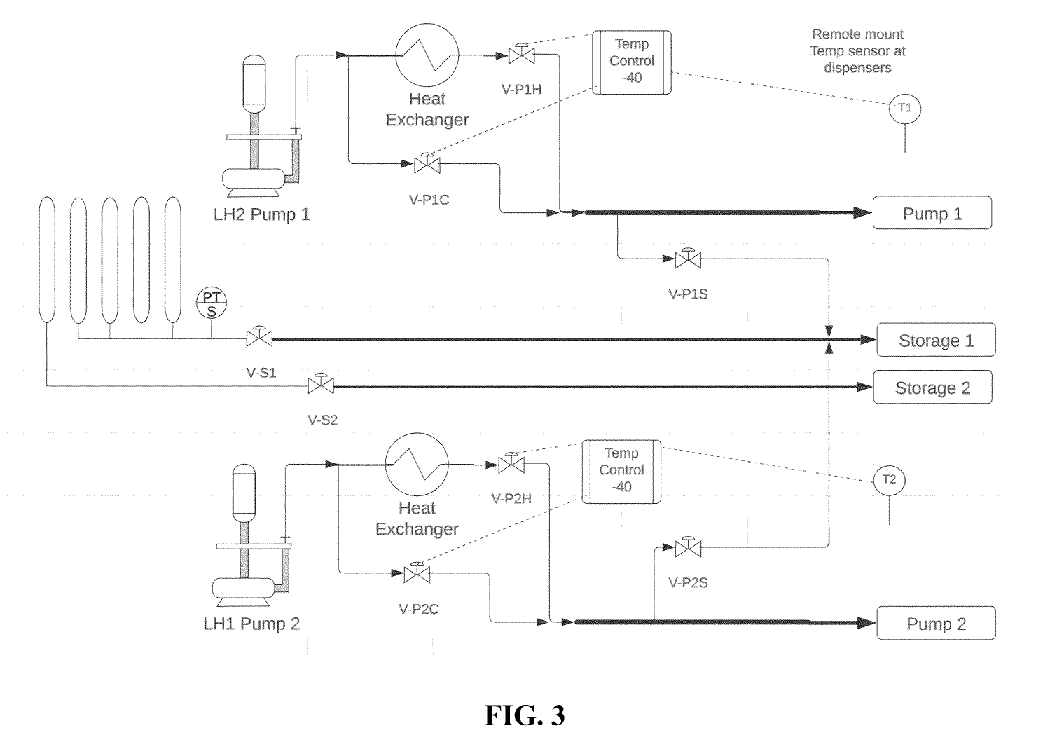

A more detailed view of the back-end of system 200 is shown in FIG. 3. A listing of the components of the backend is as follows:
VP1H Pump 1 Hot Valve.
VP1C Pump 1 Cold Valve.
VP1S Pump 1 Storage Valve
T1 Pump 1 Remote Temperature Sensor.
VP2H Pump 2 Hot Valve.
VP2C Pump 2 Cold Valve
VP2S Pump 2 Storage Valve
T2 Pump 2 Remote Temperature Sensor.
V-S1 Storage Valve 1.
V-S2 Storage Valve 2.
PT-S Storage 1 Pressure and Temperature Sensor

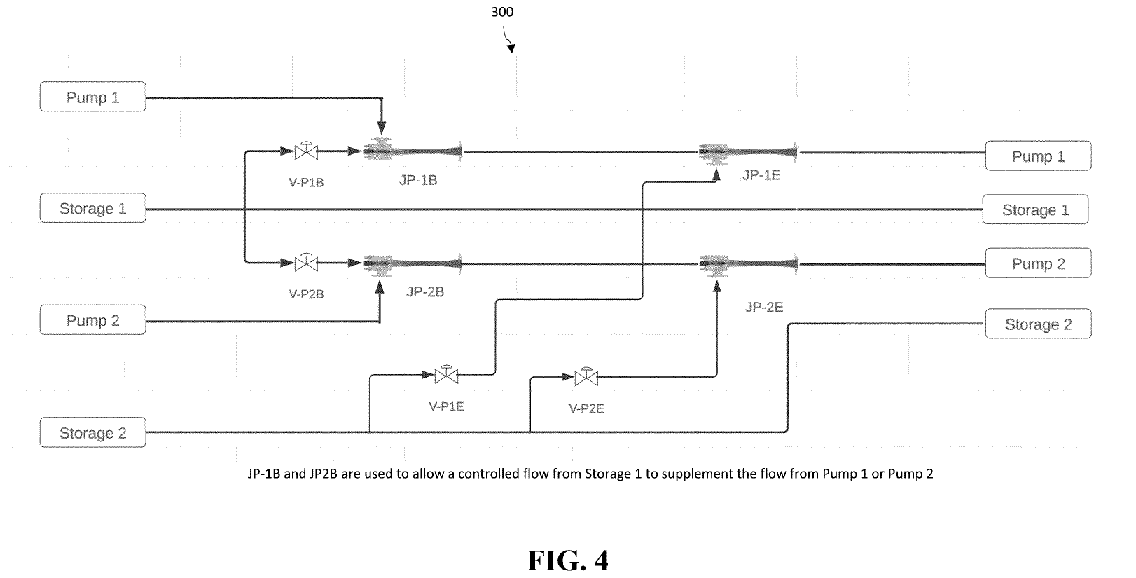

A non-limiting example of a system configured to boost and economize hydrogen fueling in order to reduce fueling times for a vehicle (not shown), hereafter referred to as the system 300 is shown in FIG. 4. JP-1B and JP2B are used to allow a controlled flow from Storage 1 to supplement the flow from Pump 1 or Pump 2. JP-1E and JP-2E are used to draw down the pressure in Storage 2 to support the dispenser precooling system.

Storage referred to herein may refer to stationary storage tanks or mobile, trailer mounted storage tanks, such as tube trailers.

The system 100 may include a switching mechanism to turn on the precooling hydrogen loop before the customer comes to the station.

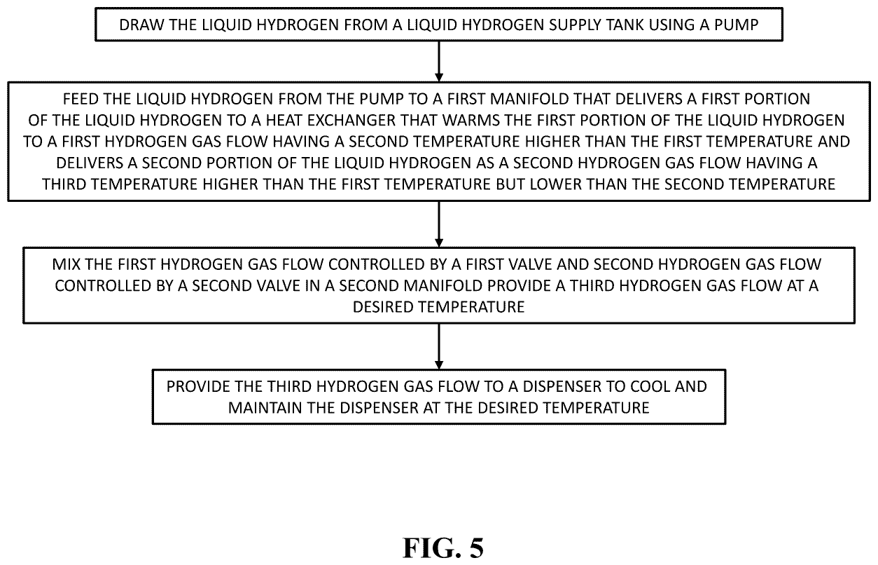

FIG. 5 shows a flow chart of a method of operating one or more of the hydrogen fueling systems 100, 200, 300.

A conventional variable area valve to control the fueling rate to comply with SAE J-2601 fueling protocols, is known to be prone for leakage that increases with use. The method presented herein eliminates a source of fugitive emissions, by removing this known leak source common with other hydrogen fueling flow control methods.

### Discussion of Possible Embodiments

The following are non-exclusive descriptions of possible embodiments of the present invention.

In some aspects, the techniques described herein relate to a hydrogen fueling system configured to provide hydrogen fuel to a vehicle, including: a hydrogen storage tank containing delivered liquid hydrogen; one or more 400 to 500 bar storage systems to store compressed hydrogen; one or more hydrogen dispensers configured to supply hydrogen fuel to the vehicle: a pump configured to move the hydrogen fuel from the liquid hydrogen storage tank and circulate the hydrogen fuel through the heat condition system to supply hydrogen at the dispenser at a desired fueling temperature: and a control system to direct pump flow through the dispenser supply system to and fill storage to precool the dispensers and direct flow from storage to supplement the flow from the pump when fueling vehicles with onboard storage greater than 250 liters.

The hydrogen fueling system of the preceding paragraph can optionally include, additionally and/or alternatively any, one or more of the following features/steps, configurations and/or additional components.

In some aspects, the techniques described herein relate to a hydrogen fueling system, further including a heat exchanger configured to bring the hydrogen fuel to the desired fueling temperature.

In some aspects, the techniques described herein relate to a hydrogen fueling system, wherein the heat exchanger is between the pump and the hydrogen dispenser.

In some aspects, the techniques described herein relate to a hydrogen fueling system, further including a manifold that separates the hydrogen fuel flowing from the pump into a first fuel flow passing through a heat exchanger and having a warm temperature and a second fuel flow having a cold second temperature that are combined in a second manifold to provide the hydrogen fuel to the dispenser at the desired fueling temperature.

In some aspects, the techniques described herein relate to a hydrogen fueling system, further including a first value configured to regulate the first fuel flow and a second valve configured to regulate the second fuel flow to provide the hydrogen fuel at the desired fueling temperature.

In some aspects, the techniques described herein relate to a hydrogen fueling system, wherein hydrogen fuel circulated through the hydrogen dispenser to precool the fueling system is directed to Storage 1 or Storage 2 and then used to supplement the flow during the subsequent fueling events.

In some aspects, the techniques described herein relate to a hydrogen fueling system, wherein hydrogen fuel circulated through the hydrogen dispenser is stored within a second hydrogen storage tank.

In some aspects, the techniques described herein relate to a hydrogen fueling system, wherein the hydrogen fuel stored in the second hydrogen storage tank is compressed hydrogen gas.

In some aspects, the techniques described herein relate to a hydrogen fueling system, wherein the hydrogen fuel stored in the second hydrogen storage tank passes through a fixed orifice and mixes with the hydrogen fuel flowing from the pump within a venturi eductor.

In some aspects, the techniques described herein relate to a hydrogen fueling system, wherein the hydrogen fuel stored in the first hydrogen storage tank is liquid hydrogen.

In some aspects, the techniques described herein relate to a hydrogen fueling system, wherein the hydrogen fuel stored in the first hydrogen storage tank is delivered liquid hydrogen.

In some aspects, the techniques described herein relate to a hydrogen fueling system configured to provide hydrogen fuel to a vehicle, including: a first hydrogen storage tank; a hydrogen dispenser configured to supply hydrogen fuel to the vehicle; a pump configured to transport the hydrogen fuel from the first hydrogen storage tank to the hydrogen dispenser; and a second hydrogen storage tank, wherein the hydrogen fuel stored in the second hydrogen storage tank passes through a fixed orifice and mixes with the hydrogen fuel flowing from the pump within a venturi eductor.

The hydrogen fueling system of the preceding paragraph can optionally include, additionally and/or alternatively any, one or more of the following features/steps, configurations and/or additional components.

In some aspects, the techniques described herein relate to a hydrogen fueling system, wherein the first hydrogen storage tank contains liquid hydrogen, and the second hydrogen storage tank contains compressed hydrogen gas.

In some aspects, the techniques described herein relate to a hydrogen fueling system, further including a heat exchanger between the pump and the hydrogen dispenser.

In some aspects, the techniques described herein relate to a hydrogen fueling system, further including a first manifold that separates the hydrogen fuel flowing from the pump into a first flow passing through the heat exchanger and having a first temperature and a second fuel flow having a different second temperature that are combined in a second manifold to provide the hydrogen fuel at a desired fueling temperature.

In some aspects, the techniques described herein relate to a hydrogen fueling system configured to provide hydrogen fuel to a vehicle, including: a first hydrogen storage tank; a second hydrogen storage tank; a hydrogen dispenser configured to supply hydrogen fuel to the vehicle; a first pump configured to transport the hydrogen fuel from the first hydrogen storage tank to the hydrogen dispenser; a second pump configured to transport the hydrogen fuel from the first hydrogen storage tank to the hydrogen dispenser, wherein said hydrogen fueling system is configured to operate in a mode selected from a list consisting of: a light duty fueling mode wherein the first pump is directly connected from the first hydrogen storage tank to the hydrogen dispenser, a medium duty fueling mode wherein the first pump is connected from the first hydrogen storage tank to the hydrogen dispenser with a medium flow from the second hydrogen storage tank, a heavy duty fueling mode wherein the first pump is connected from the first hydrogen storage tank to the hydrogen dispenser with a high flow from the second hydrogen storage tank, and a heavy duty fast fueling mode wherein the first pump and the second pump is connected from the first hydrogen storage tank to the hydrogen dispenser with a high flow from the second hydrogen storage tank.

The hydrogen fueling system of the preceding paragraph can optionally include, additionally and/or alternatively any, one or more of the following features/steps, configurations and/or additional components.

In some aspects, the techniques described herein relate to a method of operating a hydrogen fueling system configured to provide hydrogen fuel to a vehicle having a liquid hydrogen supply tank holding a quantity of liquid hydrogen at a first temperature, including: drawing the liquid hydrogen from the liquid hydrogen supply tank using a pump; feeding the liquid hydrogen from the pump to a first manifold that delivers a first portion of the liquid hydrogen to a heat exchanger that warms the first portion of the liquid hydrogen to a first hydrogen gas flow having a second temperature higher than the first temperature and delivers a second portion of the liquid hydrogen as a second hydrogen gas flow having a third temperature higher than the first temperature but lower than the second temperature; mixing the first hydrogen gas flow controlled by a first valve and second hydrogen gas flow controlled by a second valve in a second manifold provide a third hydrogen gas flow at a desired temperature; and providing the third hydrogen gas flow to a dispenser to cool and maintain the dispenser at the desired temperature.

The method of the preceding paragraph can optionally include, additionally and/or alternatively any, one or more of the following features/steps, configurations and/or additional components.

In some aspects, the techniques described herein relate to a method, wherein the third hydrogen gas flow is controlled by a third valve to precool the hydrogen supply to the dispensers and be directed to one or more compressed hydrogen storage tanks.

In some aspects, the techniques described herein relate to a method, wherein the third hydrogen gas flow is vented to a stationary fuel cell system by a fifth valve.

In some aspects, the techniques described herein relate to a method, wherein the hydrogen fueling system further includes means for integrating a fourth hydrogen gas flow controlled by a fourth valve from the liquid hydrogen supply tank into the third hydrogen gas flow by passing the fourth hydrogen gas flow through a fixed orifice and into a venturi eductor through which the third hydrogen gas flow passes.

In some aspects, the techniques described herein relate to a method, wherein, the third hydrogen gas flow will flow through the venturi eductor when a seventh valve is closed, and the third hydrogen gas flow supplements the flow from the pump flow to the vehicle.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant arts how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value. Yet further, as used herein, the term “proximate,” “proximity,” or the like may refer to a distance between objects being 20 centimeters or less, or 15 centimeters or less, or 10 centimeters or less, or 5 centimeters or less.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A hydrogen fueling system configured to provide hydrogen fuel to a vehicle, comprising:
a hydrogen storage tank containing delivered liquid hydrogen;
one or more 400 to 500 bar storage systems to store compressed hydrogen;
one or more hydrogen dispensers configured to supply hydrogen fuel to the vehicle;
a pump configured to move the hydrogen fuel from the liquid hydrogen storage tank and circulate the hydrogen fuel through a heat conditioning system to supply hydrogen at the one or more hydrogen dispensers at a desired fueling temperature; and
a control system to direct pump flow through the dispenser supply system to and fill storage to precool the one or more hydrogen dispensers and direct flow from storage to supplement the flow from the pump when fueling vehicles with onboard storage greater than 250 liters.

2. The hydrogen fueling system in accordance with claim 1, further comprising a heat exchanger configured to bring the hydrogen fuel to the desired fueling temperature.

3. The hydrogen fueling system in accordance with claim 2, wherein the heat exchanger is between the pump and the hydrogen dispenser.

4. The hydrogen fueling system in accordance with claim 1, further comprising a manifold that separates the hydrogen fuel flowing from the pump into a first fuel flow passing through a heat exchanger and having a warm temperature and a second fuel flow having a cold second temperature that are combined in a second manifold to provide the hydrogen fuel to the dispenser at the desired fueling temperature.

5. The hydrogen fueling system in accordance with claim 4, further comprising a first value configured to regulate the first fuel flow and a second valve configured to regulate the second fuel flow to provide the hydrogen fuel at the desired fueling temperature.

6. The hydrogen fueling system in accordance with claim 1, wherein hydrogen fuel circulated through the hydrogen dispenser to precool the fueling system is directed to Storage 1 or Storage 2 and then used to supplement the flow during a subsequent fueling event.

7. The hydrogen fueling system in accordance with claim 1, wherein hydrogen fuel circulated through the hydrogen dispenser is stored within a second hydrogen storage tank.

8. The hydrogen fueling system in accordance with claim 7, wherein the hydrogen fuel stored in a second hydrogen storage tank is compressed hydrogen gas.

9. The hydrogen fueling system in accordance with claim 8, wherein the hydrogen fuel stored in the second hydrogen storage tank passes through a fixed orifice and mixes with the hydrogen fuel flowing from the pump within a venturi eductor.

10. The hydrogen fueling system in accordance with claim 9, wherein the fixed orifice provides zero leakage compared to the significant fugitive emission associated with a hydrogen vehicle fueling system having a variable area control valve, thereby being inherently safer system due to less leak and wherein the venturi eductor eliminates moving parts and improves performance of the hydrogen fueling system.

11. The hydrogen fueling system in accordance with claim 1, wherein the hydrogen fuel stored in a first hydrogen storage tank is liquid hydrogen.

12. A hydrogen fueling system configured to provide hydrogen fuel to a vehicle, comprising:
a first hydrogen storage tank;
a hydrogen dispenser configured to supply hydrogen fuel to the vehicle;
a pump configured to transport the hydrogen fuel from the first hydrogen storage tank to the hydrogen dispenser; and
a second hydrogen storage tank, wherein the hydrogen fuel stored in the second hydrogen storage tank passes through a fixed orifice and mixes with the hydrogen fuel flowing from the pump within a venturi eductor.

13. The hydrogen fueling system in accordance with claim 12, wherein the first hydrogen storage tank contains liquid hydrogen, and the second hydrogen storage tank contains compressed hydrogen gas.

14. The hydrogen fueling system in accordance with claim 12, further comprising a heat exchanger between the pump and the hydrogen dispenser.

15. The hydrogen fueling system in accordance with claim 14, further comprising a first manifold that separates the hydrogen fuel flowing from the pump into a first flow passing through the heat exchanger and having a first temperature and a second fuel flow having a different second temperature that are combined in a second manifold to provide the hydrogen fuel at a desired fueling temperature.

16. A method of operating a hydrogen fueling system configured to provide hydrogen fuel to a vehicle having a liquid hydrogen supply tank holding a quantity of liquid hydrogen at a first temperature, comprising:
drawing the liquid hydrogen from the liquid hydrogen supply tank using a pump;
feeding the liquid hydrogen from the pump to a first manifold that delivers a first portion of the liquid hydrogen to a heat exchanger that warms the first portion of the liquid hydrogen to a first hydrogen gas flow having a second temperature higher than the first temperature and delivers a second portion of the liquid hydrogen as a second hydrogen gas flow having a third temperature higher than the first temperature but lower than the second temperature;
mixing the first hydrogen gas flow controlled by a first valve and second hydrogen gas flow controlled by a second valve in a second manifold provide a third hydrogen gas flow at a desired temperature; and
providing the third hydrogen gas flow to a dispenser to cool and maintain the dispenser at the desired temperature.

17. The method according to claim 16, wherein the third hydrogen gas flow is controlled by a third valve to precool the hydrogen supply to the dispenser and be directed to one or more compressed hydrogen storage tanks.

18. The method according to claim 16, wherein the third hydrogen gas flow is vented to a stationary fuel cell system by a fifth valve.

19. The method according to claim 16, wherein the hydrogen fueling system further comprises means for integrating a fourth hydrogen gas flow controlled by a fourth valve from the liquid hydrogen supply tank into the third hydrogen gas flow by passing the fourth hydrogen gas flow through a fixed orifice and into a venturi eductor through which the third hydrogen gas flow passes.

20. The method according to claim 19, wherein, the third hydrogen gas flow will flow through the venturi eductor when a seventh valve is closed, and the third hydrogen gas flow supplements the flow from the pump flow to the vehicle.
